(19) United States
(12) Patent Application Publication
(10) Pub. No.: US 2018/0353387 A1
(43) Pub. Date: Dec. 13, 2018

(54) PILL ORGANIZER

(71) Applicant: JOBAR INTERNATIONAL, INC., Carson, CA (US)

(72) Inventor: Matthew Meritt, Long Beach, CA (US)

(21) Appl. No.: 15/619,106

(22) Filed: Jun. 9, 2017

(51) Int. Cl. A61J 7/04; A61J 7/00; B65D 83/04

(52) U.S. Cl. CPC A61J 7/04; A61J 7/0007; A45C 11/24; B65D 83/0445; A61J 7/0069

(57) ABSTRACT

A pill organizer includes a housing including a plurality of internal compartments and an external compartment, at least one pill holder for being received into one of the plurality of compartments, the at least one pill holder including a plurality of chambers, and a plurality of spaced apart ribs extending from an upper surface of the housing.

### BACKGROUND OF THE INVENTION

Pill organizers are used by people that have to take multiple pills on a daily basis to keep their pills for each day organized. Pill organizers that allow for sorting, cutting and/or stacking of multiple organizers are desired.

### SUMMARY

In an example embodiment a pill organizer includes a housing including a plurality of internal compartments and an external compartment, at least one pill holder for being received into one of the plurality of compartments, the at least one pill holder including a plurality of chambers, and a rib or a plurality of spaced apart ribs extending from an upper surface of the housing, the rib or plurality of ribs being one less than the plurality of chambers. In a further example embodiment, the pill organizer also includes a pill cutter receivable in the external compartment. In an example embodiment, the pill cutter includes one of a projection or depression and the external compartment includes the other of a projection of depression, and the projection is received in the depression for mating the pill cutter to the external compartment. In another example embodiment, the pill cutter is capable of cutting pills while mated to the external compartment. In yet another example embodiment, one of the at least one pill holder is receivable in the external compartment. In a further example embodiment, the ribs extend to a first end of the housing but not to a second end opposite the first end. In yet a further example embodiment, the pill organizer further includes a lip extending from the upper surface to receive at least a foot extending from a lower surface of another pill organizer for stacking the another pill organizer on the pill organizer.

In another example embodiment a pill organizer includes a housing including a plurality of internal compartments and an external compartment, at least one pill holder for being received into one of the plurality of compartments, the at least one pill holder including at least one chamber, and a pill cutter received in the external compartment. In yet another example embodiment, the pill cutter includes one of a projection or depression and the external compartment includes the other of a projection of depression, and the projection is received in the depression for mating the pill cutter to the external compartment. In a further example embodiment the pill cutter is capable of cutting pills while mated to the external compartment.

In one example embodiment, one of the at least one pill holder is receivable in the external compartment when the pill cutter is not received in the external compartment. In a further example embodiment, the pill organizer also includes a lip extending from the upper surface to receive at least a foot extending from a lower surface of another pill organizer for stacking the another pill organizer on the pill organizer.

In another example embodiment, a pill organizer includes a housing including a plurality of internal compartments and an external compartment, at least one pill holder for being received into one of the plurality of compartments, the at least one pill holder including at least one chamber, and at least one channel formed on an upper surface of the housing. In yet another example embodiment, the at least one chamber is a plurality of chambers and the at least one channel is a plurality of channels and the plurality of channels is equal to the plurality of chambers. In one example embodiment, the pill organizer also includes a pill cutter receivable in the external compartment. In a further example embodiment, the pill cutter includes one of a projection or depression and the external compartment includes the other of a projection of depression, and the projection is received in the depression for mating the pill cutter to the external compartment. In one example embodiment, the pill cutter is capable of cutting pills while mated to the external compartment. In another example embodiment, one of the at least one pill holder is receivable in the external compartment. In yet another example embodiment, the pill organizer further includes a lip extending from the upper surface to receive at least a foot extending from a lower surface of another pill organizer for stacking the another pill organizer on the pill organizer.

In yet another example embodiment, a pill organizer housing includes a plurality of internal compartments each for receiving a pill holder, and an external compartment for receiving a pill holder. In one example embodiment, the housing includes an outer surface including a plurality of channels leading to the external compartment.

### BRIEF DESCRIPTION OF THE DRAWINGS

FIG. 1 is a perspective view of an example embodiment pill organizer.

FIG. 2 is an example embodiment of the housing of the pill organizer depicted in FIG. 1.

FIG. 3 is a front end view of the pill organizer housing depicted in FIG. 2.

FIG. 4 is a perspective view of an example embodiment pill holder used with the example embodiment pill organizer depicted in FIG. 1.

FIG. 5 is a perspective view of the example embodiment pill holder shown in FIG. 4 with the lids in an open position.

FIG. 6 is a perspective view of an example embodiment pill cutter used in the example embodiment pill organizer depicted in FIG. 1.

FIG. 7 is a partial cross sectional view of the peripheral lip extending from an upper wall of the example embodiment housing depicted in FIG. 2.

FIG. 8 is a bottom perspective view of the example embodiment housing shown in FIG. 2.

FIG. 9 is a partial cross sectional view of the feet extending from the example embodiment housing shown in FIG. 2.

FIG. 10 is a partial cross section view of the example embodiment lip shown in FIG. 1 engaging an example embodiment foot of a different housing.

### DETAILED DESCRIPTION

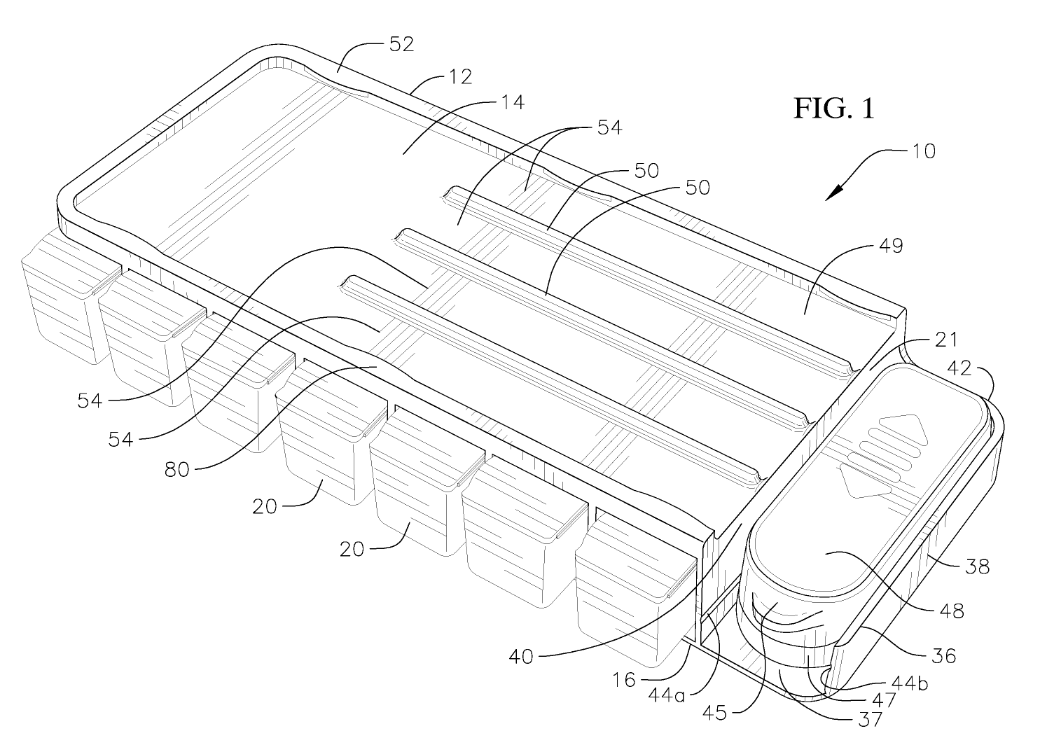

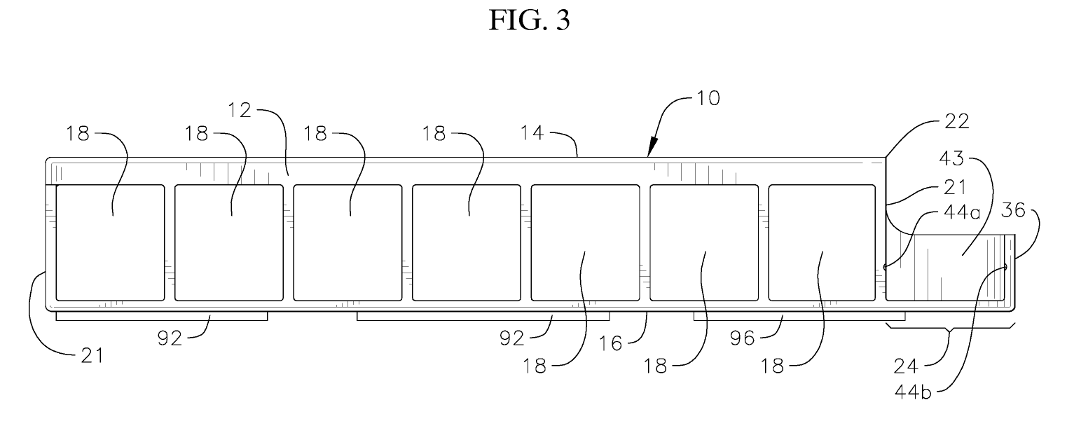

A pill organizer 10 according to an example embodiment, includes a housing 12 or case which in an example embodiment has an upper wall 14 opposite and spaced apart from a lower wall 16, as for example shown in FIGS. 1, 2 and 3. Multiple compartments 18 are formed between the upper and lower walls. In an example embodiment, seven compartments 18 are formed each for receiving a pill holder 20 for each day of the week. In an example embodiment, compartments are defined by compartment walls 19 extending between the upper and lower walls. A peripheral wall 21 extends between and bridges the upper and lower walls defining the entire housing except at the portion of the housing where the compartments are formed. In the shown example embodiment, the housing is rectangular and the peripheral wall extends along the three sides of the rectangular housing that do not form an entry for the compartments. In an example embodiment, the lower wall 16 extends beyond one end 22 of the upper wall 14 defining an extension 24.

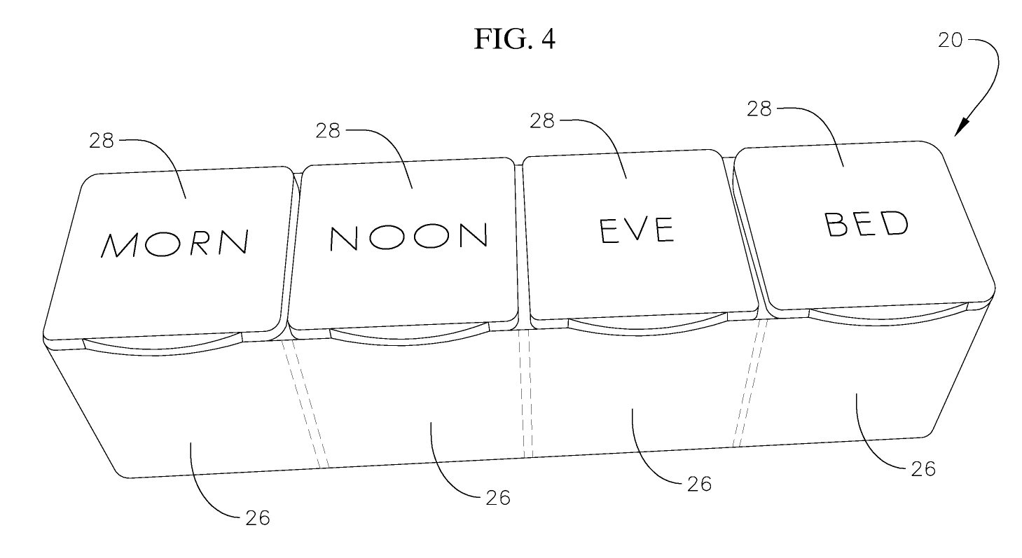

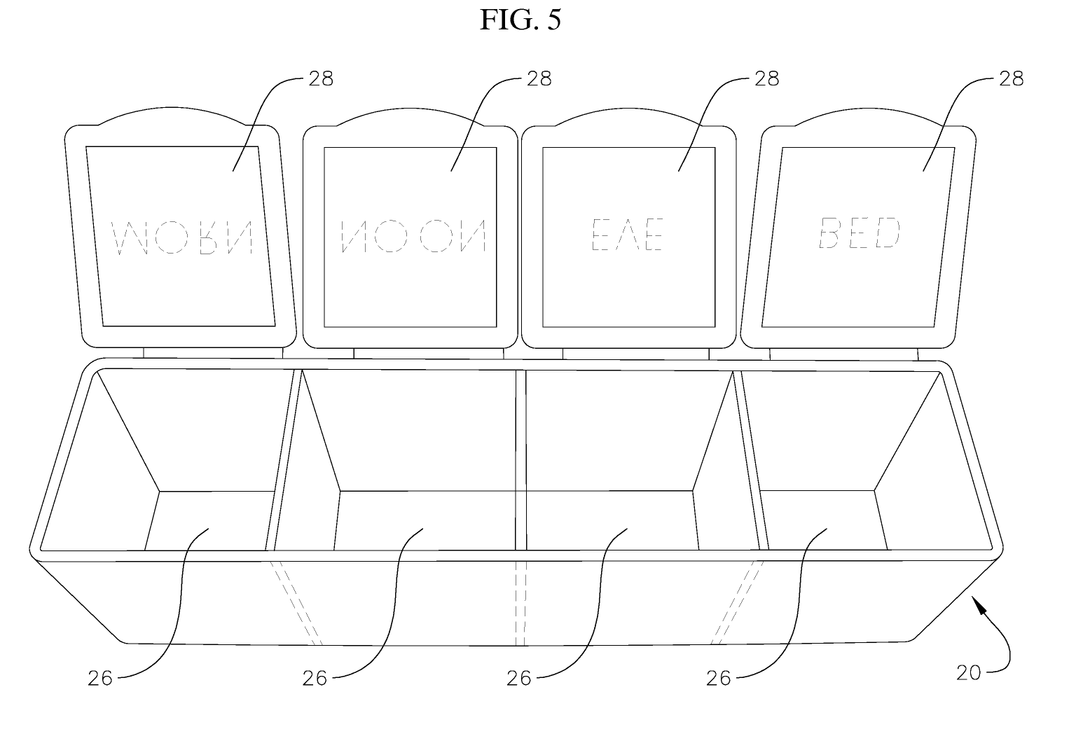

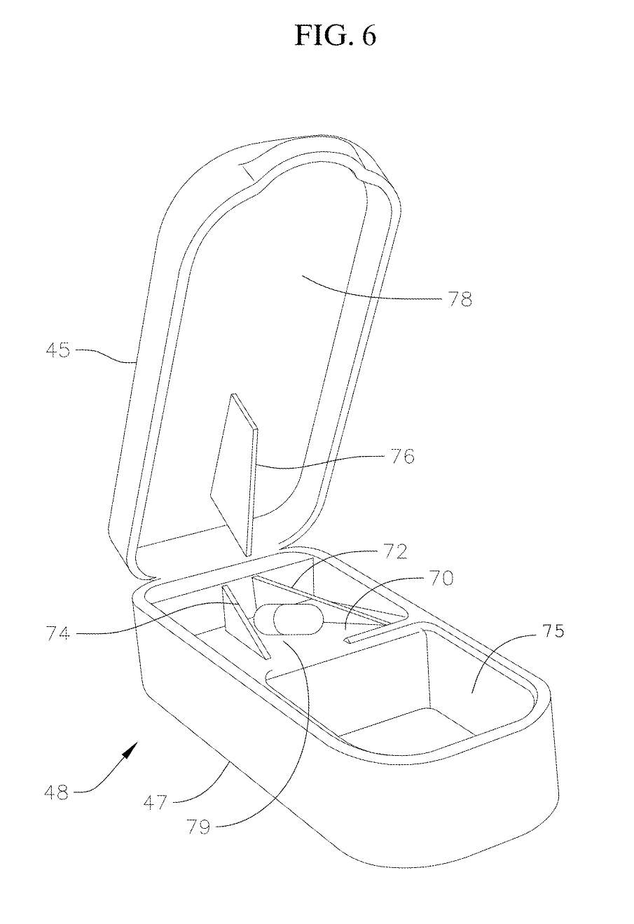

In an example embodiment, each pill holder may have multiple pill holding chambers. In an example embodiment shown, there are four pill holding chambers 26 in each pill holder 20, as for example shown in FIGS. 4 and 5. One chamber, for example, may be for morning pills, one may be for noon pills, the other for evening pills and the other one for bedtime pills. The pill holder may include lids 28 for each pill holder chamber or may include a lid for multiple chambers. Each lid may be marked appropriately for the pills it is to receive. The lids maybe hingeably coupled to the housing. In an example embodiment each lid may also include a projection 30 extending from an inner surface of the lid at a location opposite the location where the lid is hinged to the housing. In an example embodiment, the projection 30 frictionally engages an inner surface of its corresponding chamber to snap lock the lid closed over its corresponding chamber.

The housing compartments and the pill holders are designed such that pushing the pill holder into a compartment will cause the pill holder to be engaged by friction by its corresponding compartment. For example, each compartment may include at least a ramp proximate its rear end. In one example embodiment, two ramps 32 are provided extending from an inner surface of the upper wall, as for example shown in FIG. 5. The ramps increase in height in a direction toward the rear of the compartment. In this regard, the pill holders engage the ramp and are frictionally held in place. In another example embodiment, side pads 34 may also be included at a rear of the compartment extending from opposite compartment walls that may also engage the pill holders to provide additional frictional support.

In an example embodiment, the portion 24 of the lower wall extending beyond the upper wall may include a lip 36 extending from an end thereof and spaced apart from the peripheral wall 21 defining an external compartment 37. In an example embodiment the housing is rectangular. The lip includes a first portion 38 parallel to, and spaced apart from, a portion 40 of the peripheral wall 21 defining the external compartment 32 for receiving a pill cutter 48 or any of the pill holders 20. A second portion 42 of the lip extends from the first portion to the peripheral wall. Parallel grooves 44a, 44b are formed along the portion 40 and an inner surface of the first portion 38 of the lip, respectively. These grooves define a guide for receiving corresponding ribs formed on the pill cutter 48. In another example embodiment, the ribs may be formed in the portion 40 of the peripheral wall 21 and in the inner surface first portion 38 of the lip and the grooves may be formed on the pill cutter. In this regard the pill cutter ribs may be slid into the corresponding grooves 44a, 44b, and the pill cutter will be mated to the housing and retained in position on the housing. In an example embodiment, the pill cutter includes an upper portion pivotably hinged to a lower portion 47 and the corresponding ribs (or grooves) are formed on the lower portion. In this regard when the pill cutter is mated to the housing, the upper portion may be pivoted relative to the lower portion to allow a pill to be received in the lower portion and to be cut when the upper portion is pivoted to a closed position relative to the lower portion.

The pill 48 includes a pill receiving section 70. In an example embodiment, the pill receiving section 70 is a sloped channel in that it has two sides 72, 74 defining the channel, which slope toward each other in a direction towards the rear of the pill cutter. A collection bin 74 is formed forward of the slope channel. A cutting blade, as for example, a steel cutting blade 76 extends from the inner surface 78 of the upper portion of the pill cutter. In use, a pill is placed in the slope channel such that its wedged or retained by the sloped side 72, 74. The upper portion of the pill cutter is then close relative to the lower portion causing the blade to extend through a mid-plane of the slope channel and to cut the pill in half. The cut pill halves may then be moved to be collected in the collection bin. In an example embodiment, a floor 75 of the pill receiving section has a floor 79 that slopes downward in a direction toward the rear of the pill receiving section so that the pill to be cut slides against the sides 72, 74.

In a further example embodiment, the upper wall 14 of the housing on its upper surface 49 has a plurality of parallel ribs 50 as well as a lip 52 extending along the perimeter of the upper surface except along the portion 40 of the peripheral wall. The ribs define channels 54 between the ribs and between a rib an adjacent portion of the lip 52. In an example embodiment, the number of channels defined is equivalent to the number of pill holder chambers in each pill holder. In the example embodiment shown, each pill holder includes four chamber. With this embodiment, three parallel ribs 50 are formed defining four channels 54. Moreover, the ribs do not extend along the entire length of the upper surface of the upper wall. Rather, they extend from the portion 40 of the peripheral wall and along more than half of the length of the housing. In this regard, pills may be placed in the portion 60 of the upper surface of the upper wall not including the ribs but surrounded by the lip can be sorted such that an appropriate pill for each daytime, as for example, morning, noon, evening and bedtime may be lined up along a corresponding channel. A pill holder 20 then is placed into the external compartment 37. The lids of the pill holder are raised and by moving or lifting the housing at an angle the pills may slide along their corresponding channels into their corresponding chambers into the pill holder.

In an example embodiment, where the housing is rectangular, the housing may be stored such that it rests on its lower wall or the portions of the peripheral wall forming the rear end of the compartments or the portion opposite the external compartment.

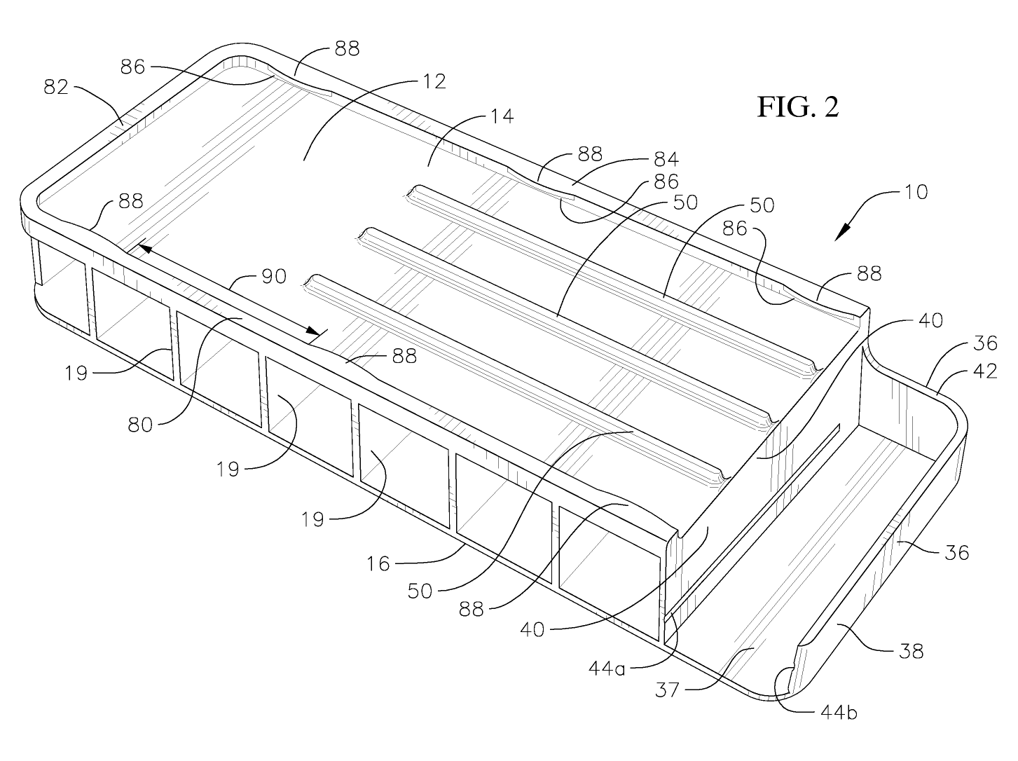

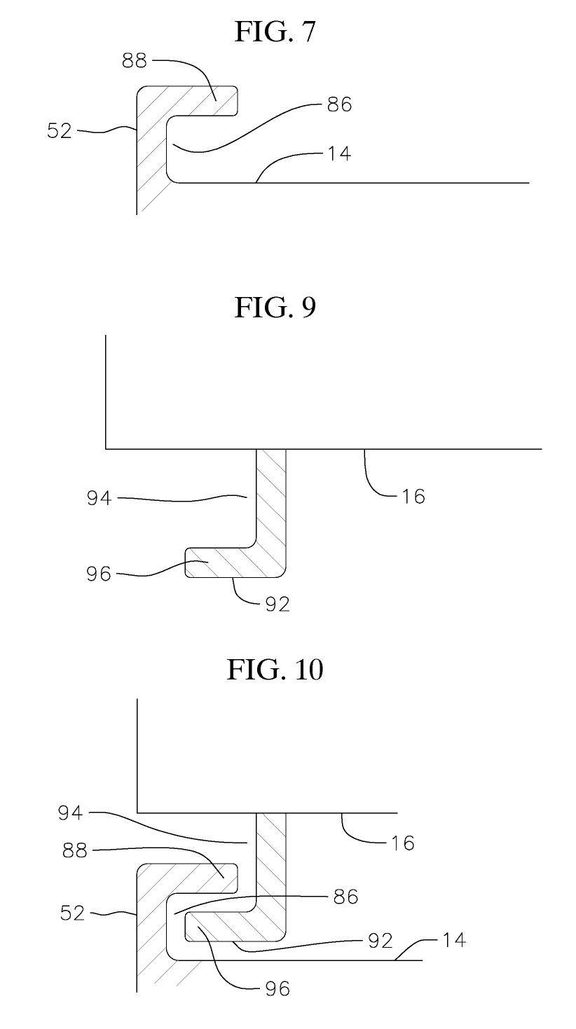

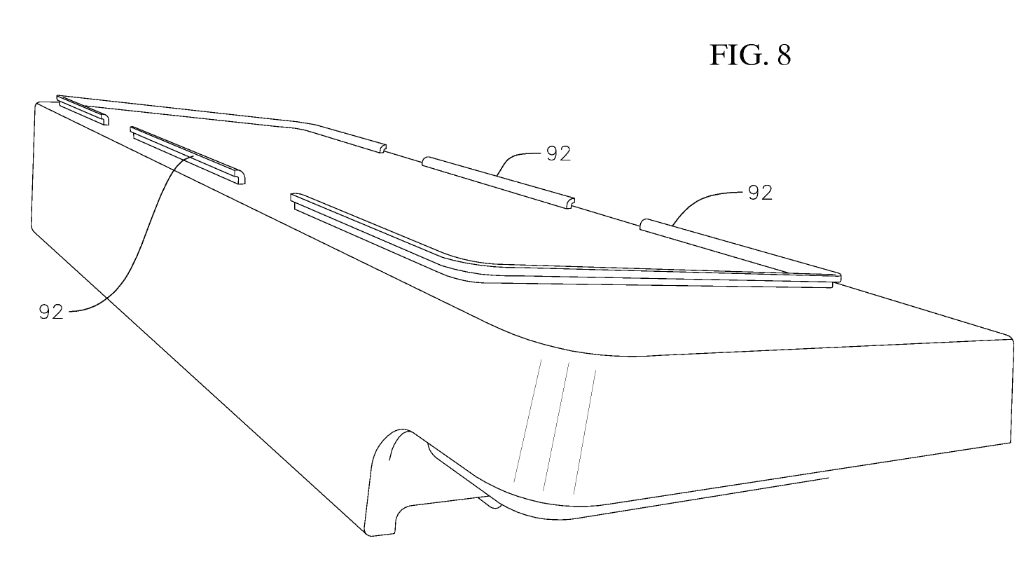

In the example embodiment where the housing is generally rectangular in shape, the lip 52 extends upward from the upper wall along a first or a front side of the housing through which the compartments are formed defining a first lip portion 80. The lip also extends along an end of the housing opposite the peripheral portion 40 defining a second portion 82 and has a third portion 84 opposite the first portion at the rear of the housing defining a third portion 84. The lip begins and ends at the peripheral portion 40. In this regard, the lip has a first portion 80, a third portion 84 spaced apart from the first portion which is interconnected by a second portion 82. One or more channels 86 are defined along the first and third portions of the lip, as for example shown in FIGS. 1, 2 and 7. These portions are defined by an overhang 88 extending from the lip, as for examples shown in FIG. 7. In an example embodiment, where multiple channels are formed on each of the first and third portions of the lip, they're formed along the same length on each portion and are equally spaced apart, as for example shown in FIGS. 1 and 2. In an example embodiment, each lip channel is spaced apart by a distance 90 from an adjacent channel along the first and third portions of the lip. Feet 92 extend downward from the lower wall of the housing, as for example shown in FIGS. 8 and 9. In an example embodiment, the length of each foot 92 is less than the distance 90 between adjacent lip channels. The feet also form channels, as for example shown in FIG. 9. The feet 92 also define an inner channel 94 defined by projection portion 96. In an example embodiment, the housings are stackable such that the feet may be slid within the distance 90 between adjacent channels of the lip formed on the upper wall and then slid such that the channel 86 interlocks with the channel 94, as for example shown in FIG. 10 and one housing locks against the other. In an example embodiment, to unlock, one housing may be pushed relative to the other housing to release the feet channels from the lip channels. Yet, a further example embodiment, the lip does not include the channels 86 nor do the feet include the channels 94. Rather, the housing still remains stackable with the feet of one housing received within the lip 52 of the other housing.

The shape of the pill holder does not have to be rectangular or cubical as shown in the example embodiment disclosed herein. In another example embodiment, the pill holder may be oval in cross section. The housing compartments may be accordingly designed such that they will hold the pill holders in position.

While example embodiments have been described herein, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention.

1. A pill organizer comprising:
a housing comprising,
a plurality of internal compartments, and
an external compartment;
at least one pill holder for being received into one of said plurality of compartments, said at least one pill holder comprising a plurality of chambers; and
a rib or a plurality of spaced apart ribs extending from an upper surface of the housing across at least one of said plurality of internal compartments and extending toward said external compartment, said rib or plurality f ribs being one less than said plurality of chambers.

2. The pill organizer of claim 1, further comprising a pill cutter receivable in said external compartment.

3. The pill organizer of claim 2, wherein pill cutter comprises one of a projection or depression and wherein the external compartment comprises the other of a projection depression, wherein the projection is received in the depression for mating the pill cutter to the external compartment.

4. The pill organizer of claim 3, wherein the pill cutter is capable of cutting pills while mated to the external compartment.

5. The pill organizer of claim 1, wherein one of said at least one pill holder is receivable in said external compartment.

6. The pill organizer of claim 1, wherein the ribs extend to a first end of said h using but not to a second end opposite the first end.

7. The pill organizer of claim 1, further comprising a lip extending from the upper surface to receive at least foot extending from a lower surface of another pill organizer for stacking said another pill organizer on said pill organizer.

8. A pill organizer comprising:
a housing comprising,
a plurality of internal compartments, and
an external compartment;
at least one pill holder for being received into one f said plurality of compartments, said at least one pill holder comprising at least one chamber; and
a pill cutter received in said external compartment, wherein pill cutter comprises one of a protection or depression, wherein the external compartment comprises the other of a projection or depression, and wherein the projection is received in the depression for mating the pill cutter to the external compartment.

9. (canceled)

10. The pill organizer of claim 8, wherein the pill cutter is capable of cutting pills while mated to the external compartment.

11. The pill organizer of claim 8, wherein one of said at least one pill holder is receivable in said external compartment when said pill cutter is not received in said external compartment.

12. The pill organizer of claim 8, further comprising a lip extending from an upper surface to receive at least a foot extending from a lower surface of another pill organizer for stacking said another pill organizer on said pill organizer.

13. A pill organizer comprising:
a housing comprising,
a plurality of internal compartments, and
an external compartment;
at least one pill holder for being received into one of said plurality of compartments, said at least one pill holder comprising at least one chamber; and
at least one channel formed on n upper surface of the housing, said at least one channel extending over end across at least one of said plurality of internal compartments, wherein each of said at least one channel defines a path extending to said external compartment.

14. The pill organizer of claim 13, wherein the at least one chamber comprises a plurality of chambers and wherein the at lest one channel comprises a plurality of channels and wherein said plurality of channels is equal to said plurality of chambers.

15. The pill organizer of claim 13, further comprising a pill cutter receivable in said external compartment.

16. The pill organizer of claim 15, wherein the pill cutter comprises one or a projection or depression and wherein the external compartment comprises the other of a projection of depression, wherein the projection is received in the depression for mating the pill cutter to the external compartment.

17. The pill organizer of claim 16, wherein the pill cutter is capable of cutting pills while mated to the external compartment.

18. The pill organizer of claim 13, wherein one of said at least one pill holder is receivable in said external compartment.

19. The pill organizer of claim 13, further comprising a lip extending from the upper surface to receive at least a font extending from a lower surface of another pill organizer for stacking said anther pill organizer on said pill organizer.

20. A pill organizer housing comprising:
a plurality of internal compartments bounded an upper and a lower wall, each internal compartment for receiving a pill holder; and
an external compartment for receiving a pill holder, said external compartment extending bounded by the lower wall, and wherein each of the plurality of internal compartments and the external compartment has an axis along which it receives a pill holder, wherein all of said axes are parallel to each other.

21. The housing of claim 20 wherein the housing comprises an outer surface comprising a plurality of channels leading to said external compartment.

22. A pill organizer comprising:
a housing comprising,
a plurality of internal compartments, and
an external compartment;
at least one pill holder for being received into one of said plurality of compartments, said at least one pill holder comprising a plurality of chambers;
a rib or a plurality of spaced apart ribs extending from an upper surface of the housing, said rib or plurality of ribs being one less than said plurality of chambers; and
a pill cutter receivable in said external compartment.

23. A pill organizer comprising:
a housing comprising,
a plurality of internal compartments, and
an external compartment;
at least one pill holder for being received into one of said plurality of compartments, said at least one pill holder comprising at least one chamber;
at least one channel formed on an upper surface of the housing; and
pill cutter receivable in said external compartment, wherein the pill cutter comprises one of a projection or depression, wherein the external compartment comprises the other of a projection of depression, and wherein the projection is received in the depression for mating the pill cutter to the external compartment.

24. The pill organizer of claim 1 wherein said rib or plurality of ribs do not extend across all of said plurality if internal compartments.
